(19) United States
(12) Patent Application Publication
(10) Pub. No.: US 2010/0057530 A1
(43) Pub. Date: Mar. 4, 2010

(54) System and Method for Electronic Transactions and Providing Consumer Rewards

(76) Inventors: James Parivash, Los Altos, CA (US); Pirooz Parvarandeh, Los Altos Hills, CA (US)

Correspondence Address: SQUIRE, SANDERS & DEMPSEY L.L.P., 1 MARITIME PLAZA, SUITE 300, SAN FRANCISCO, CA, 94111, US

(21) Appl. No.: 12/203,597

(22) Filed: Sep. 3, 2008

(51) Int. Cl. G06Q 30/00

(52) U.S. Cl. 705/10; 705/14.23

(57) ABSTRACT

A system and method for electronic transactions involves a website that displays an advertisement of a merchant. The website includes a feature that allows a visitor to the website to commit to making a purchase from the merchant within a certain period of time. The website visitor is encouraged to make the purchase by a commitment made by the merchant to donate or giveback a portion of the purchase value. When the website visitor actually makes a purchase from the merchant at a later time, the system and method allows for identification of the visitor as somebody who earlier made a purchase commitment, thereby allowing the merchant to determine whether to make a donation and to determine the effectiveness of the advertisement.

### BACKGROUND OF THE INVENTION

1. Field of the Invention

This invention relates generally to commercial transactions and, more particularly, to electronic advertising and transactions.

2. Description of the State of the Art

Advertisers have long had difficulty in evaluating the effectiveness of their advertisements. Advertisers can ask persons who make purchases from them for information on what prompted the purchase. The information given is prone to inaccuracy and obtaining such information at the point of sale could be overly intrusive or inconvenient. Any information obtained is likely to be insufficient to pinpoint where and when the advertisement was seen by the purchaser. Advertisements often include coupons, which when used, can give the advertiser an indication of what prompted the purchase without having to get information from the purchaser. A problem with coupons is that they can be misplaced or they can be forgotten in one's purse or wallet during the time of purchase.

Merchants often post advertisements electronically, via e-mails to prospective purchasers or via websites displaying text and/or graphic banner advertisements. Such advertisements may include a unique discount code that can be used by a purchaser when making a purchase online or at the merchant's physical retail space. A problem with using such coded coupons is that the purchaser must remember to use them. Also the code, which is often a long string of letters and numbers, is easily forgotten or misplaced if printed on a piece of paper.

Some electronic advertisements that are posted or communicated via the Internet allow viewers to click or select the advertisement, which brings the viewer to the merchant's retail website. If the viewer subsequently makes a purchase, the merchant would get some indication of the effectiveness of the advertisement. A problem with such a method is that it cannot be used by a merchant that does not make sales via a retail website. Another drawback is that the viewer, after being directed to the merchant's retail website, may decide to visit the merchant's physical place of business to better examine a product or to get more information about a product or service. A purchase made at the physical place of business would not be associated with the earlier “click” that was made on the electronic advertisement, thereby resulting in an inaccurate indication of advertisement effectiveness.

Accordingly, there is a need for a system and method that provides for accurate tracking of advertisement effectiveness. There is also a need for a system and method that does not require the consumer to remember a code or carry a coupon in order to take advantage to a discount or other incentive.

### SUMMARY OF THE INVENTION

Briefly and in general terms, the present invention is directed to an electronic transaction system and method. In aspects of the present invention, the system comprises a server and a sales terminal. The server is adapted to send data to a user terminal operated by a user, the data enabling the user terminal to display an advertisement of a merchant and to allow the user to initiate sending of commitment information to the server, the commitment information indicating a commitment by the user to make a future purchase from the merchant, the commitment information including data regarding the identity of the user. The sales terminal is adapted to send purchase information to the server, the purchase information indicating performance by a purchaser of a purchase from a seller, the purchase information including data regarding the identity of the purchaser. The server is further adapted to determine whether the purchase is valid by comparison of the identity of the purchaser and the identity of the user, and further adapted to allocate a giveback value to a recipient only if the purchase is valid.

In other aspects of the present invention, the method comprises causing a user terminal operated by a user to display an advertisement of a merchant and an input element, receiving commitment information generated in response to an input by the user at the input element, the commitment information indicating a commitment by the user to make a future purchase from the merchant, the commitment information including data regarding the identity of the user, receiving purchase information indicating performance of a purchase by a purchaser from a seller, the purchase information including data regarding the identity of the purchaser, determining whether the purchase is qualified for a giveback value, the determining of purchase qualification including comparing the identity of the purchaser against the identity of the user, and allocating the giveback value to a recipient only when the purchase is qualified, the giveback value being a function of a value of the performed purchase.

The features and advantages of the invention will be more readily understood from the following detailed description which should be read in conjunction with the accompanying drawings.

### BRIEF DESCRIPTION OF THE DRAWINGS

FIG. 1 is a diagram of a system in accordance with an embodiment of the present invention.

FIG. 2 is a diagram of a display screen showing a website.

FIG. 3 is a diagram of a system in accordance with another embodiment of the present invention.

FIG. 4 is a diagram of a system in accordance with a further embodiment of the present invention.

FIG. 5 is a flow chart of a method in accordance with an embodiment of the present invention.

FIG. 6 is a diagram of a system in accordance with yet another embodiment of the present invention.

FIGS. 7 and 8 are diagrams of relationships between entities involved in the system of FIG. 6.

### DETAILED DESCRIPTION OF THE INVENTION

Referring now in more detail to the exemplary drawings for purposes of illustrating embodiments of the invention, wherein like reference numerals designate corresponding or like elements among the several views, there is shown in FIG. 1 a system 10 for electronic transactions that includes a server 12, a user terminal 14, and a sales terminal 16. The server 12, user terminal 14, and sales terminal 16 communicate with each other through a network 18. The network can include any combination of conventional wire and wireless communication means, including but not limited to the Internet, local area networks, wide area networks, telephone networks, mobile phone networks, cable television networks, and satellite communication networks.

In one embodiment, the system 10 can be used to provide an incentive for a person at the user terminal 10 to make a future purchase in response to an advertisement and to allow the advertiser, which can be any provider of goods and/or services, to determine whether that person actually makes the purchase, thereby providing an indication of advertising effectiveness. In use, the person may decide to make a commitment to make a purchase from the advertiser after viewing the advertisement. As an incentive to fulfill the commitment, the advertiser has agreed to give back a predetermined amount or a portion of the purchase price. This giveback value is given to the user or to one or more recipients of the user's choice. The advertiser may place a time limit on the when the future purchase must be made to be eligible for the giveback value. When a purchase is made at some time in the future, the advertiser can determine whether it corresponds to a previously made commitment and thereby determine whether the purchase qualifies for the giveback value. The giveback may not always be a function of the value of the purchase. In some embodiments, it may be a fixed amount. In other embodiments, the giveback may increase if the user is able to demonstrate that he referred friends to the same store, and that they made a purchase as a result of the first user's referral.

Referring again to FIG. 1, the server 12 is adapted to send data 20 to the user terminal 14 which is operated by a user. The data enables or causes the user terminal to display an advertisement of a merchant.

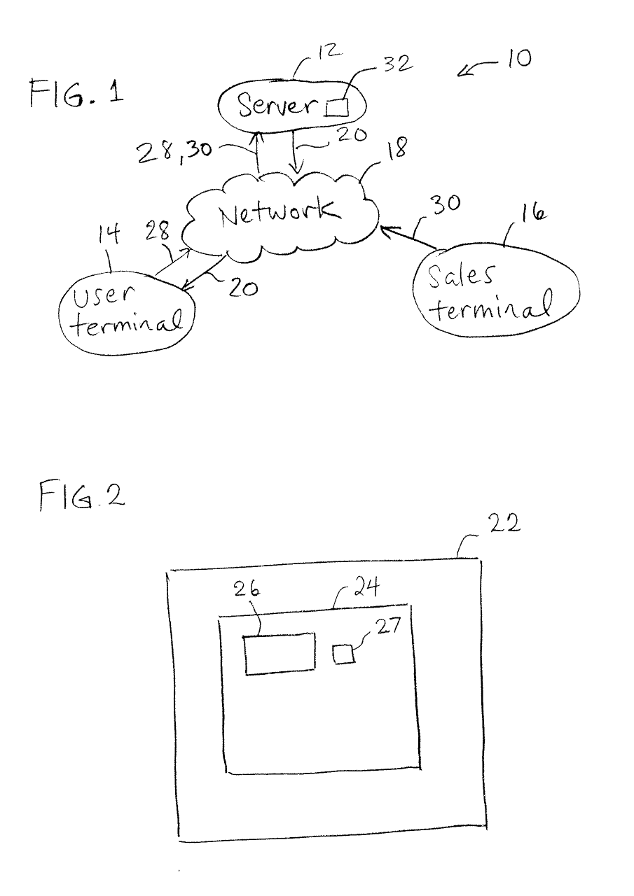

In one embodiment, as shown in FIG. 2, the data 20 represents hypertext mark-up language (HTML) and enables a video display screen 22 of the user terminal 14 to display a web page 24 via a web browser running on the user terminal. The advertisement is in the form of a graphical banner 26 within the web page 24.

Referring back to FIG. 1, the data 20 also allows the user to initiate sending of commitment information 28 to the server 12. The commitment information indicates an intention or commitment by the user to make a purchase from the merchant in the future. Preferably, though not necessarily, the commitment information includes data regarding the identity of the user. In the illustrated embodiment, the commitment information comes from the user terminal 14.

The user initiates sending of the commitment information 28 by means of an input element 27. As shown in FIG. 2, the data 20 causes an input element 27 to be displayed on the web page 24. The input element 27 can be graphic button, which could be selected or activated by the user via a pointing device, such as a mouse or touch pad, associated with the user terminal 14 or by touching the graphic button if the video display screen 22 is touch sensitive.

In other embodiments, the input element 27 can be part of the graphical banner 26 or the entire graphical banner 26 can serve as the input element 27. In other embodiments, the input element 27 can take other forms, such as but not limited to, a text input field, a hyperlink, and hypertext. In some embodiments, the input element does not appear on a display screen and the user makes a commitment to purchase by pressing a particular key or combinations of keys on a keypad.

In other embodiments, the commitment information 28 may come from an intermediate device in communication with the user terminal 14 and the server 12. In which case, the user terminal 14 sends to the intermediate device a commitment indicator or message indicating that the user has clicked on, or otherwise acted upon, the input element 24. The commitment indicator triggers the intermediate device to send commitment information to the server 12. The intermediate device can be another server or a database containing data regarding the identity of the user.

The sales terminal 16 is adapted to send purchase information 30 to the server 12. The purchase information indicates performance by a purchaser of a purchase from a seller. Preferably, though not necessarily, the purchase information includes data regarding the identity of the purchaser. The purchaser may or may not be the same person as the user who previously indicated a commitment to make a future purchase in response to viewing the merchant's advertisement. The server 12 is further adapted to determine whether the purchase is valid by comparing the identity of the purchaser and the identity of the user, and further adapted to allocate a giveback value to a recipient only if the purchase is valid.

In another embodiment, the commitment information 28 further indicates that the future purchase will be made within an allowable time period. The allowable time period can be specified in advance by the merchant, communicated as part of the advertisement, and be included in the commitment information 28 sent to the server 12. In this embodiment, the purchase information also indicates that the performance of the purchase was at a particular time. In this way, the server 12 can be further adapted to determine whether the purchase is valid by also comparing the particular time of performance and the allowable time period.

It is also possible that seller from which the purchase was made is not the same merchant that placed the advertisement. To handle this situation, the commitment information 28 in other embodiments can further include data regarding the identity of the merchant that placed the advertisement. Also, the purchase information 30 from the sales terminal 16 can further include data regarding the identity of the seller from which the purchase was made. In this way, the server 12 can be adapted to determine whether the purchase is valid by also comparing the identity of the seller and the identity of the merchant.

Referring once again to FIG. 1, the server 12 optionally includes a memory 32 for storing the commitment information 28 together with an allocation rule. The allocation rule can be specified by the user prior to actually making the purchase. The allocation rule identifies a group of user-selected recipients and user-selected amounts from the giveback value that is to be allocated among the various recipients. For example, the user may specify that 10% of the giveback value be allocated to a school, 20% of the giveback value be allocated to the Red Cross, and 70% of the giveback value be allocated to a local homeless shelter. In this way, the server 12 can be further adapted to allocate the user-selected amounts to the user-selected recipients. The server 12 can also be further adapted to send user-specific data to the user terminal 12 that enables the user terminal 14 to display a menu for defining the allocation rule. The menu is adapted to allow the user to select the group of recipients from a list of pre-qualified recipients.

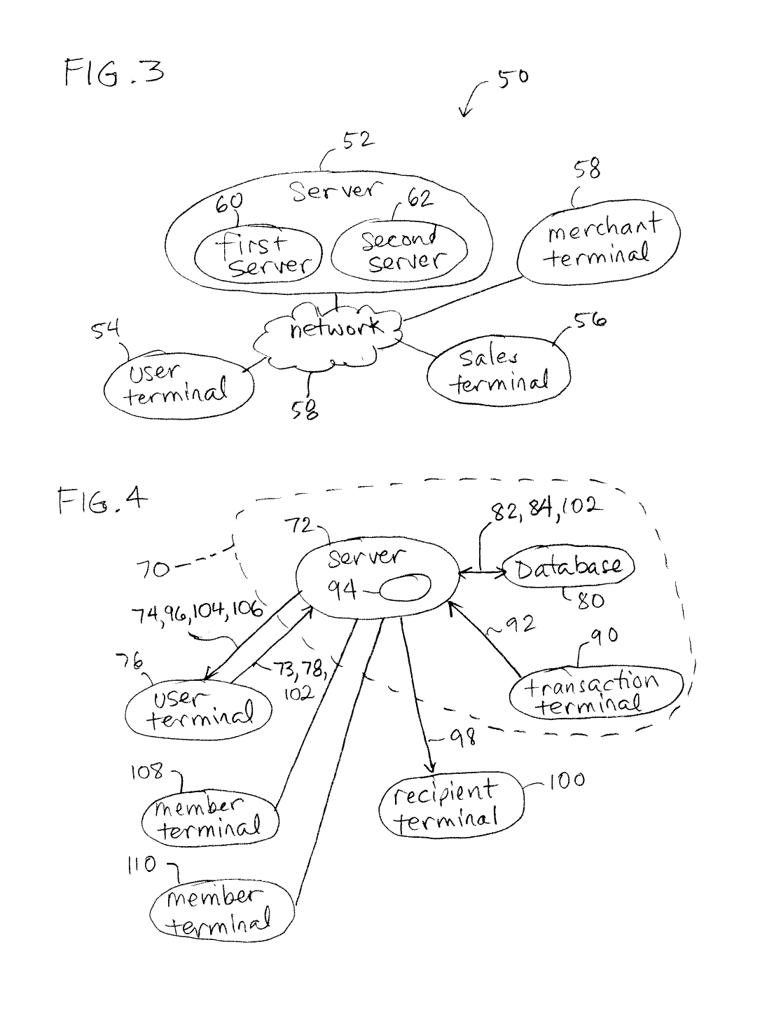

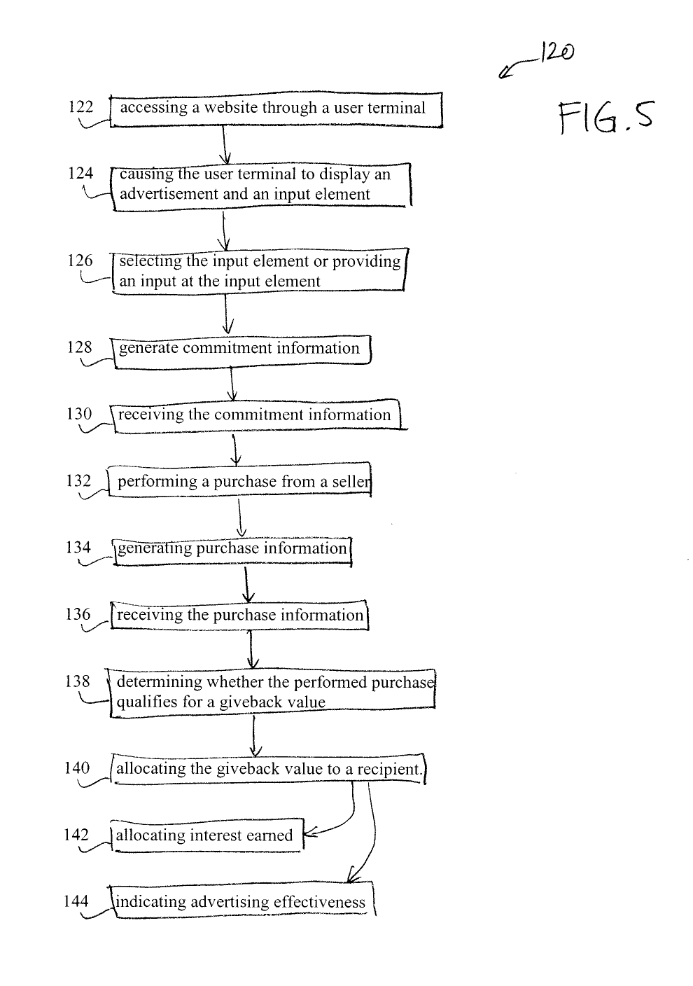

FIG. 3 shows another system 50 for electronic transactions. The system 50 includes a server 52, user terminal 54, sales terminal 56, and a network 58, all of which perform the same functions as similarly-named elements in the system 10 of FIG. 1. System 50 also includes a merchant terminal 58 that is operated by the merchant that placed the advertisement. The server 52 is adapted to send merchant-specific data to the merchant terminal 58 that indicates advertisement effectiveness as a function of validated purchases. A non-limiting examples of advertisement effectiveness can be the number of validated purchases for a particular advertisement, and the ratio of the number of validated purchases and the number of purchase commitments that were made for a particular advertisement.

The server 52 can include any number of interconnected processors or servers, which can be housed in the same building or in separate buildings controlled by the same or different corporate or institutional entities. The server 52 can be a server farm or a cluster of servers that accomplish server needs beyond the capability of one machine. In the illustrated embodiment, the server 52 includes a first server 60 and a second server 62. The first server 60 is adapted to send the data enabling the user terminal to display the advertisement. The first server 60 can be controlled by the merchant or by an entity to which the merchant gives payment for the advertisement. The second server 62 is adapted to validate the purchase and allocate the giveback value. The second server 62 can be controlled by a financial institution. In some embodiments, the second server 62 is also adapted to determine interest earned by the financial institution on the giveback value. In other embodiments, the first and second servers 60, 62 are controlled by the same corporate or institutional entity.

FIG. 4 shows a system 70 that can provide incentives for viewers of an advertisement to make a purchase and allow advertisers to determine the degree to which their advertisements actually result in a purchase. The system 70 comprises a server 72 adapted to send data 74 to a user terminal 76 operated by a user. The data 74 that is sent causes the user terminal 76 to display an advertisement of a merchant and to display an input element that, when acted upon by the user, causes the user terminal to send a commitment indicator 78. The commitment indicator 78 is a message indicating a commitment by the user to make a future purchase from the merchant. The user may decide at a later time whether to fulfill the commitment by making a purchase from the merchant. Preferably, the advertisement includes information regarding an incentive for fulfilling the commitment. The incentive can be in the form of a reward provided by the merchant if the user fulfills the commitment.

The system 70 also includes a database 80 in communication with the server 72. The database 80 contains a merchant giveback rule 82 and commitment information 84. The giveback rule 82 defines the reward, which can be specified by the merchant. The commitment information 84 corresponds to the commitment indicator 78 initiated by the user. The commitment information 84 can be generated by the server 72 in response to the commitment indicator 78 from the user terminal 76. Preferably, the commitment information includes a user identifier that uniquely identifies the user.

When the user acts upon the input element, the resulting commitment indicator 78 is associated with the user identifier. The user identifier can be any one or a combination of a user alias adopted by the user, password, postal code, some digits of the user's telephone number, some digits of the user's social security number, and some digits of the user's credit card.

The user identifier can be provided by the user via a keypad or keyboard when acting upon the input element. The user identifier can also be provided by the user in advance by registering a user identifier in the server 72 prior to acting upon the input element. The registered user identifier can then be stored in the database 80. When the commitment indicator 78 is received by the server 72, the commitment indicator 78 is automatically associated with the registered user identifier stored in the database 80.

In other embodiments, user's terminal can be identified if the user chooses so, and he does not have to identify himself again.

The system 70 also includes a transaction terminal 90 in communication with the server 72. The transaction terminal 90 is adapted to provide transaction information 92 regarding a purchase transaction between a buyer and a seller. The buyer may or may not be the same person as the user who made the purchase commitment. Preferably, the transaction information includes a buyer identifier that uniquely identifies the buyer so that it can be determined whether the buyer is qualifies for an incentive. The buyer identifier can be any one or a combination of a user alias adopted by the user, password, postal code, digits of the user's telephone number, digits of the user's social security number, and digits of the user's credit card. The buyer identifier can, for example, be entered into a keypad or keyboard located at the point of sale or entered via a credit card reader.

In order to determine whether the buyer qualifies for an incentive, the server 72 includes logic 94 for determining whether the buyer identifier corresponds to the user identifier. In some embodiments, the incentive is in the form of a giveback from the merchant. The giveback value is a function of the merchant giveback rule 82 provided by the database 80 to the server 72. In some embodiments merchant giveback rule corresponds to a percentage, and the logic 94 determines the giveback value by applying the percentage to the transaction value.

The logic 94 is also for allocating the giveback value to one or more recipients only if the buyer identifier corresponds to the user identifier. Thus, it will be understood that the logic 94 allocates the giveback only when the performed purchase qualifies by means of matching buyer and seller identifiers.

Alternatively or in addition to the matching buyer and seller identifiers, qualification of the purchase can be by means of matching merchant and seller identifiers. To allow this, the commitment information 84 provided by the database 80 to the server 72 can further include a merchant identifier that uniquely identifies the merchant over other merchants. Also, the transaction information 92 provided by the transaction terminal 90 to the server 72 can further include a seller identifier that uniquely identifies the seller over other sellers.

Alternatively or in addition to the above, qualification of the purchase can be by means of satisfying a time constraint. For example, the commitment indicator 78 could indicate that a future purchase will be made within a valid time. In which case, the commitment information 84 can further include a valid time datum, such as an expiration date, a date on which the user acted upon the input element, or a number of days or hours. Also, the transaction information 92 can further includes a transaction time datum, such as a date and time of day. In this way, the logic 94 can allocate the giveback value to the one or more recipients only if the transaction time datum agrees with the valid time datum in addition to or as an alternative to the previously described means of qualification.

In some embodiments, the data 74 causing the user terminal 76 to display the advertisement is sent by the server 72 in response to a search criterion 73 provided by the user via the user terminal. The search criterion 73 can involve one or more of a postal code, a geographic name, a product name, a category of goods, a category of service, a category of seller, and a seller name. For example, the server 72 can be adapted to handle a web site that includes a search function for finding businesses, products, and services. A person viewing the web site can then enter the search criterion, such as the name of a city and type of product the person is interested in purchasing. In response, the web site returns a list of businesses where the product is available, including advertisements and associated input elements from some of the businesses listed.

Referring again to FIG. 4, the server 72 can also be adapted to send user-specific data 96 to the user terminal 76. The user-specific data 96 causes the user terminal 76 to display a menu for specifying allocation of the giveback value. The displayed menu can be adapted to allow the user to select recipients from among a plurality of recipients and to assign an allocation percentage of the giveback value to each one of the selected recipients. Each one of the plurality of recipients can be an educational organization, a religious organization, a humanitarian organization, a community organization, a charitable organization, a governmental organization, a library, the user, or a lottery ticket purchasing agent. Information or criteria specifying allocation of the giveback value is referred to herein as an allocation rule 102.

The database 80 can store the allocation rule 102 specified by the user. The logic 94 is then able to allocate amounts from the giveback value to a plurality of escrow accounts in accordance with the allocation rule, wherein each of the escrow accounts corresponds to a recipient. The server 72 can be further adapted to send other user-specific data 104 to the user terminal 76, which causes the user terminal to display amounts allocated to the plurality of escrow accounts in accordance with a criterion selected by the user. The criterion can be in terms of purchases made by the user, purchases made by a plurality of persons, purchases made from a particular seller, and purchases made from a group of sellers. For example, the user terminal can display amounts allocated to particular escrow accounts based on purchases made by the user only or by purchases made by a group of users. As a further example, the user terminal can display amounts allocated to the escrow account of one seller to the escrow accounts of a group of sellers.

The server 72 is also adapted to send recipient-specific data 98 to a recipient terminal 100 operated by a particular recipient. The recipient-specific data 98 causes the recipient terminal 100 to display an amount allocated to the particular recipient.

The server 72 can be adapted to send further user-specific data 106 to the user terminal 76, which causes the user terminal to allow the user to join a group of users of the server. In some embodiments, the user-specific data 106 causes a menu to be displayed. The menu is to allow the user to become a member of a group of users selected by the user, and the user-specific data 106 enables the user terminal 76 for communication between the user and members of the selected group of users. Those members can be using other terminals 108, 110 in communication with the server 72.

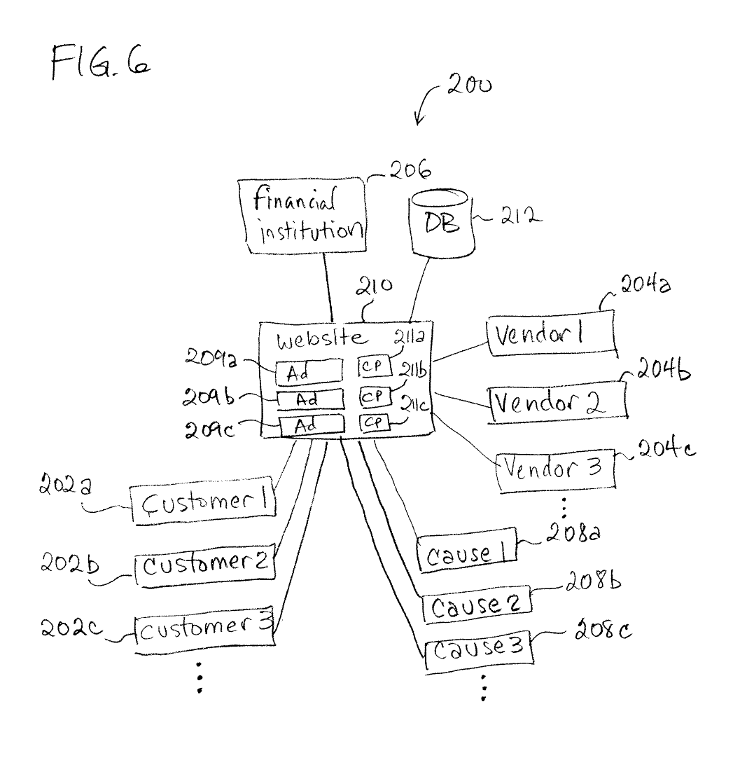

FIG. 5 shows an embodiment of a method in accordance with aspects the present invention. Although the method will be described in terms of elements with names used in connection with the systems 10, 70 of FIGS. 1 and 4, it will be appreciated that other systems may be used to implement the method.

The method 120 includes the user accessing 122 a web site controlled by a server. The user accesses 122 and views the web site using a user terminal running a web browser. In the response, the server causes 124 the user terminal operated by the user to display an advertisement of a merchant and to display an input element.

The advertisement and input element are displayed on a web page of the web site. The input element can be a button labeled “commit to purchase.” The user acts upon or selects 126 the input element, which can include positioning a cursor over the input element by means of a pointing device, such as a mouse.

The user's action 126 or input at the input element is communicated to the server. In response, the server generates 128 commitment information. The commitment information indicates a commitment by the user to make a future purchase from the merchant. A memory or a database associated with the server receives 130 the commitment information.

The method 120 further includes a purchaser initiating or performing 132 a purchase from a seller of goods and/or services. The purchase can be made via the Internet on a web site operated by the seller or by another entity. The purchase can also be made via a telephone call made by the user to the seller or to the seller's distributor or agent. The purchase can also be made at the seller's physical store or other physical place of business. The seller, seller's distributor, seller's agent, or other entity will generate 134 purchase information including data regarding the identity of the purchaser. The purchase information can be generated by a cash register, a credit card reader, a microprocessor, or a terminal located at the point of sale, telephone call center, or other place of business. The purchase information can be generated 134 by another server that controls, hosts, or monitors the retail web site from which the purchase was made.

Next, the server receives 136 the generated purchase information and determines 138 whether the performed purchase is qualified for a giveback value. In some embodiments, the determining of purchase qualification includes comparing the identity of the purchaser against the identity of the user. The purchase qualifies and the give back value is allocated 138 to a recipient only if the identities match.

Optionally, allocating the giveback value includes transferring funds to an escrow account accessible by the recipient. The method 120 can further include allocating 140 earned interest to a party other than the recipient, wherein the interest has been earned on the funds transferred to the escrow account.

The server could, optionally, send data to the user terminal to indicate 144 advertising effectiveness as a function of a number of qualified purchases associated with the advertisement.

The server in the above method 120 can be under the control or owned by the merchant or a entity that allows the advertisement to be displayed on its web site for a fee. Alternatively, the server can be under the control or owned by a financial institution, such as an issuer of credit cards or debit cards or an operator of an electronic payment network.

FIG. 6 shows a diagram of a system 200 in accordance with aspects of the present invention. The system 200 involves four types of entities: a customer 202, a vendor 204, a financial institution 206, and optionally a cause 208. As used herein, a cause can be an educational organization, a religious organization, a humanitarian organization, a community organization, a charitable organization, a governmental organization, a library, the user, and a lottery ticket purchasing agent. The financial institution 206 can be a credit card company or operator of an electronic payment network. In the system 200, whenever a financial transaction is made—usually, but not necessarily, with a credit card—each of the entities receives a benefit. The system 200 includes the following elements.

A vendor places an Internet advertisement (“ad”) 209 on a web site 210 that services many vendors, such as shown in FIG. 6. The web site 210 can be similar in function to a convention yellow pages telephone book. In some embodiments, the web site 210 includes several advertisements 209 from one or more vendors 204.

Adjacent to the ad, there is a “commit to purchase” (“CP”) button 211 that can be used by a customer. When the customer clicks this CP button, the customer is registering an intent to purchase goods from the vendor within a predetermined period of time. The customer does not have to go through with the purchase, but if the customer does so within the predetermined period of time, the customer is rewarded by the vendor as will be described below.

The customer's name and some other identifying characteristics are stored in a database 212 associated with the web site 210. Non-limiting examples of identifying characteristics include the last 4 digits of the customer's social security number, and/or several digits of a credit card number. The identifying characteristics preferably includes sufficient information to identify the customer when they enter a vendor's store. It is highly unlikely for two individuals to have the same name, the same limited set of digits on their credit cards, and the same last four digits of their social security numbers. In addition or alternatively, the identifying characteristic can be a customer name of our registered party.

There are a number of concerns with regard to privacy and security. The above examples for identifying characteristics contain information that is limited in such a way to protect the privacy of the customer while allowing the customer to register and be uniquely identified on the web site. For instance, the customer's complete credit card information or complete social security information need not be taken and stored. By limiting the amount of information requested from the customer, the customer is made comfortable with registering in the web site 210.

Various other methods for obtaining a customer's identifying characteristics can be implemented. The following are three examples.

(a) Get the full information of the customer into the database 212. For example, when the customer presents a credit card owned by the customer, the customer can be automatically and uniquely identified by the financial institution 206 that issued the credit card.

(b) Get partial information from the customer and have the customer enter the last four digits of their social security number or some pre-determined PIN# when making a transaction. The point of sale terminal will see that there is a match with the name and the partial credit card numbers or pin, and may ask for additional information to verify the identity of the customer.

(c) If a limited amount of information is entered, the system may need to determine if any other user with identical information has registered. If so, then the system will progressively ask for more information until uniqueness is established.

With continued reference to FIG. 6, the database 212 registers which customers clicked the CP button 211 on a particular advertisement 209.

It will be appreciated that the present invention can be implemented on cell-phones, smart phones, personal digital assistants, hand-held devices, and other portable electronic devices in order to take advantage of location dependant advertising. Such advertising can appear on the portable electronic devices. Customers can go through a similar procedure of registering intent to make a purchase from the advertiser.

Preferably, vendors 204 who have ads placed and have provided a CP button for the customer 202 also make a commitment to reward the customer if the customer comes through with a purchase. This commitment is some form of remuneration that can optionally be predetermined by the vendor. For example, the remuneration can be a percentage of the purchase price that is put into escrow by the financial institution 206. The amount put into escrow can be used for purposes specified by the customer 202. In this way, the vendor 204 only rewards the customers who clicked his ad and came through with a purchase.

Statistics or information can also be provided with regard to the effectiveness of the vendor's ad. In cases where the vendor's advertisement is shown in multiple web sites, such information on effectiveness can include identification of web sites that brought customers to the vendor to make a purchase. Such information serves as feedback to the vendor, which allows the vendor to determine which websites are more effective and provides an indication on whether to modify an advertisement to make it more effective. This solves a classic problem that Internet advertisers face, that is, not knowing which ad resulted in a purchase. Thus, it will be appreciated that the present invention allows a vendor to reward web sites that are more effective in bringing in buying customers. The reward can be in terms of the vendor paying the web site a higher fee to increase or enhance the display frequency, position in the web site, or size of the vendor's advertisement.

The customer 202 that actually makes a purchase in response to the vendor's ad also benefits by having a percentage of her purchase price set aside in escrow by the financial institution 206. Preferably, though not necessarily, the customer 202 specifies how she wants this escrow amount to be disbursed. Some customers may want a first percentage of these funds to go to their personal accounts, a second percentage to go to various charities or causes they want to support (e.g., local schools or churches), and a third percentage to go towards the purchase of lottery tickets by the system. In this way, the customer has the opportunity to get a personal financial benefit as well as the opportunity to steer proceeds towards a social cause she supports.

It will thus be appreciated that, as various customers specify the same cause, an online community can be formed around that particular cause. For example, there can be a community of customers that are committed to supporting a local school in a particular city. Members of this and other online communities can get access to one another via the web site 210 either by using pseudonyms or their real identities. The web site 210 can generate reports of how much money was gathered towards the particular cause. Members would then be motivated to encourage their friends to register on the web site and join them in supporting the particular cause. Where the particular cause is a school 208, one parent of a child attending the school could lobby other parents of children attending the same school to register on the web site 210 and designate the school 208 as a recipient of proceeds from future purchases. The same situation can occur with respect to members of a church or other type of local or nationally recognized cause 208.

The web site 210 can also generate reports regarding the total contribution to each cause 208 and vendors 204 that have contributed the most to a particular cause. In this way, vendors would want to participate in the advertisement-rewards program of the system 200 when other vendors similarly situated in terms of location and/or prestige are also supporting the particular cause.

Referring again to FIG. 6, whenever a credit card purchase or transaction occurs, the financial institution 206 accesses the database 212 to determine whether the transaction matches a customer that clicked on the CP button of a vendor within a predetermined period of time. If there is a match, the financial institution 206 puts aside the percentage that was specified by the vendor into an escrow account. The credit card company also distributes the percentage according to the customer's predetermined allocation for various causes.

The financial institution 206 benefits because there is an encouragement to use credit cards. Optionally, the credit card company can earn some interest on the funds in escrow as a further incentive or reward. The escrow also acts as a bank and dispositions the funds when the various causes 208 decide to withdraw the funds.

The causes 208 also benefit from the advertisement-rewards program of the system 200 since the transactions provide a source of funds. The causes 208, therefore, have an incentive to promote the use of the system 200 to increase the funds they receive. To promote the use of the system 200, the causes could provide the web site 210 with information as to how the funds they received are used, thereby allow customers 202 who designated the cause to know that the funds were put to good use.

It will be appreciated that the advertisement-rewards program of the system 200 provide benefits to various types of entities, thereby encouraging the various entities to “spread the word” or encourage use of the system 200 by others.

In the above described embodiments, the transactions, reporting of results, allocation of funds, and other functions are done electronically. In other embodiments, some of these function may not be done electronically.

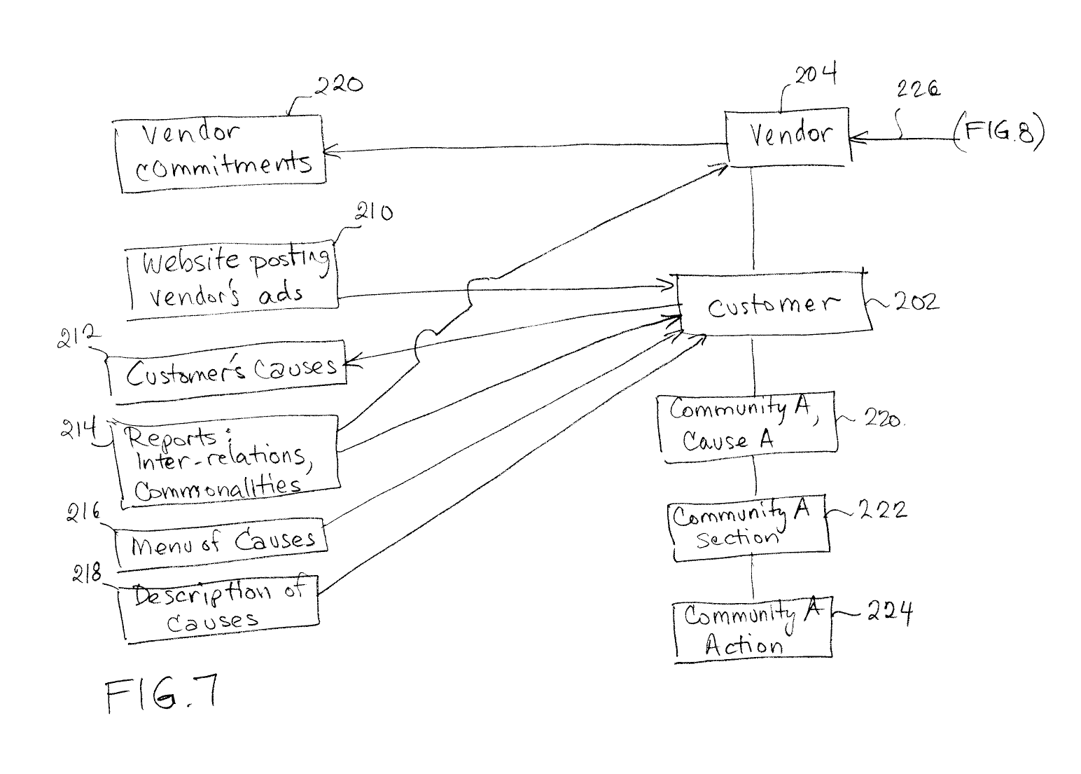

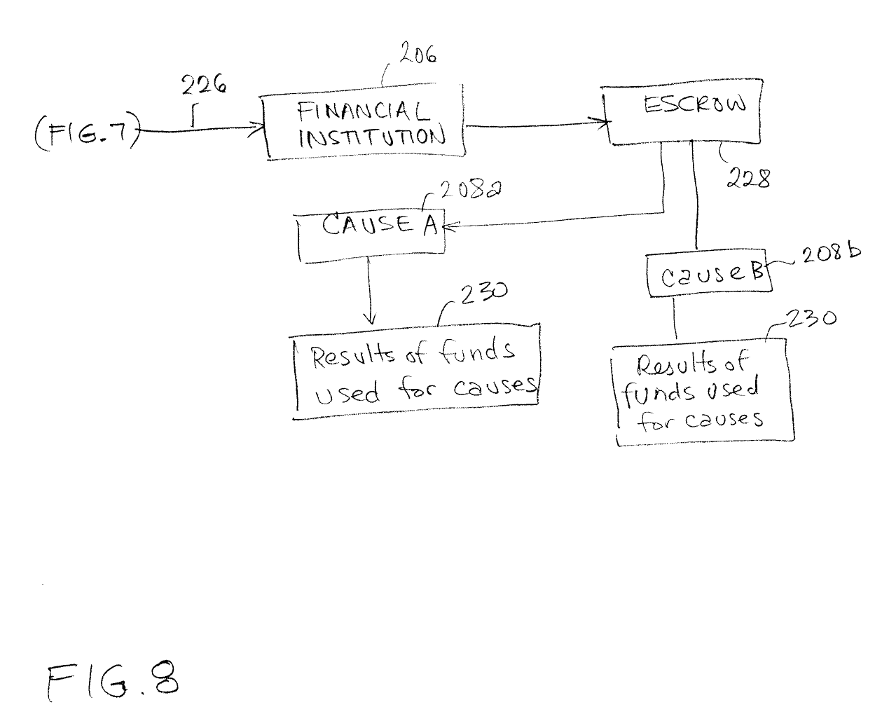

FIGS. 7 and 8 show the relationships between the various entities involved in the system 200 of FIG. 6. FIGS. 7 and 8 also show information that is provided or received by the various entities.

The vendor 204 provides a vendor commitment 220 indicating that the vendor commits to pay into escrow a certain percentage of a purchase of a qualified customer. Preferably, to be qualified, a customer makes his purchase at the vendor's store or web site within a certain time period after he has clicked the vendor's ad or CP button associated with the ad.

The customer 202 views the web site 210 on which the vendor posts an advertisement. The advertisement can come up as a result of a search initiated by the customer. The search parameters can be geographical or involve a physical location, such as a postal or zip code. Other search parameters can include the nature of the product or service that is being offered. Preferably, vendors who want their ads posted will pay some monthly fee for having their ads available on the web site. The vendors can get reports on how many people clicked on their ads, and how many of those people subsequently made a purchase at their physical or online store. The web site could sell more prominently placed advertising space for a higher price.

As a benefit to using the web site 210, the customer 202 is allowed to specify the particular causes 212 to which proceeds are donated after the customer makes a purchase. Customers who visit the web site 210 receive multiple benefits. First, customers are looking for a product or service. The reason they want to visit this web site is because if they click an ad and “commit” to buy a product, a certain percentage of their purchase will be donated by the vendor to the customer's causes. In this way, customers can have donations automatically made to a local school, to their church, to a humanitarian cause, or even to themselves. The customer can select from a menu of causes. The customer can have many causes and can specify what percentage of the proceeds can go to which cause. This allocation can be changed on some periodic basis as the customer becomes more or less interested in supporting one cause or another. The vendors might offer incentives to the customers based on the causes the customers choose. Preferably, the vendors cannot deny the cause the customer chooses, nor can they go lower than their baseline commitment. Preferably, the vendors can only amplify on their commitment if they want to particularly support a cause.

In other embodiments, a vendor may also specify that it will match givebacks to a certain cause. For example, the vendor might advertise that it will match 50% of the giveback to support a local high school. This is another way for the vendor to be part of the community and to advertise his commitment to certain causes.

The present invention also allows the customer 202 to have access to reports on inter-relations and commonalities 214. That is, the customer is allowed to see how much his contribution has been to each cause. The customer can also see how much other people have contributed to the cause. Also, the customer can see how which vendors have been most prolific or effective in contributing to all causes. It will be appreciated that a variety of other reports can be generated to show contributions and effectiveness in raising funds. These reports can form the basis of a competition among various customers. Customers can form groups that have common causes. They can use these reports as a basis of competition and to recruit other people into signing up. For example, a school that is the beneficiary of these funds can advertise among its students and parents that the more people they signup, the better it is for the school. A church might urge its members to sign up so that a percentage of their purchases go to the church. If a group is falling behind in receiving contributions, it is possible for the group to rally its members based on these reports to recruit more people into the system. This is one mechanism for creating “virality” in the system.

The present invention also allows the vendor 204 to have access to reports on inter-relations and commonalities 214. The vendor can get a report on how effective his ad has been. For example, the vendor could see that a first number of people have clicked on his ad, a second number of people committed to buying from him, a third number of people actually bought from him, and a certain amount of money has gone into escrow as a result of these purchases.

Preferably, the customer 202 has access to a menu of causes 216. These causes can include publicly recognized and sanctioned causes, such as schools, libraries, and charities. The cause can also be channel for contributions to an investment fund for an individual, which can be the customer, customer's child, or other person. The cause can also be a channel for collecting funds for automatic purchasing of lottery tickets on a regular basis. The web site 210 or purchasing agent can then determine which of the purchased lottery tickets have won.

The customer 202 also has access via the web site 210 to a description of the causes 218. Each pre-qualified cause can be given a web page in the web site that shows what it does in general and why customers should designate it as a recipient of donations. The web page can show statistics and information on what is being done with the donated funds it is receiving.

The vendor 204 can be of various types. Non-limiting examples can be an online entity, a physical store, or business that has an online and physical presence. The web site 210 can describe the vendor's products and/or services. The web site 210 could have a link to another web site, which is controlled or dedicated to the vendor. The web site controlled or dedicated to the vendor could also have a link to the web site 210 to allow customers access to the advertisement-reward program of the present invention.

As previously indicated, any number of communities 220 can form around a common cause. A particular customer can identify himself as someone who wants to participate in conversations with others in the same community. For example, one community may consist of the people who are donating these funds to a particular high school. They could talk about mobilizing others by means of real-time text or chat functions offered on the web site 210. They could also talk about other issues and events concerning the school. This community can have members who are anonymous and who use aliases during conversations, or people can decide to reveal their names. Threads of conversation can be formed where people can start a topic and others can respond to it. A mechanism similar to a wiki can be formed where there is collaborative creation of content that is relevant to the school. A wiki is a collection of web pages designed to enable anyone who accesses it to contribute or modify content.

The community that is formed need not be limited to one cause or to a particular geographic range. For example, a customer may decide to join a community that has a single “pet” cause, a community that supports multiple causes, or a community that does not have a common cause but is focused on an a common geographic location, common political affiliation, or other common interest.

The website 210 can provide a web page or section 222 that is dedicated to the community 220. The community can form the content of the community's web page 222. Non-limiting examples of content include community member blogs, chat rooms, links of interest, and other content. Some of the content may be posted by community members and voted on by other members as to whether or not to keep the content on the community's web page. The community's web page 222 can provide a means 224 to call or recruit others into the community and to participate in fundraisers, social events, and other activities.

In other embodiments, the website 210 can include or provide a web page building tool or other customization tool that enables community members to easily and conveniently form and arrange content on web page 222 dedicated to the community 220.

The financial institution 206 will have access to the database 212 that shows what the vendor's commitments are, which customer made a commitment to a vendor and when that commitment was made. When a purchase is made, the financial institution 206 can then determine whether the purchase is valid—that is, whether the purchase has met the requirements for a contribution by the vendor to the cause. The relationship 226 between the vendor and the financial institution 206 can be based on the customer's use of a credit card issued by the financial institution for a purchase from the vendor.

If the purchase is valid, the funds that the vendor committed will be put into escrow 228 for a period of one month or other period of time. The escrow then disburses these funds to the causes 208 that have been specified by the customer. Each cause 208 has a bank account from which it can withdraw. Thus, it will be appreciated that the advertisement-reward program of the system 212 functions, in some aspects, like a banking system that holds on to the funds until they are withdrawn. The financial institution 206 would be motivated to participate in the advertisement-reward program because it wants more credit card use for purchases, and because it can hold and earn interest on funds in the escrow account until such funds are withdrawn. The cause 208 can generate a report 230 on the website 210 or elsewhere indicating how much it received in funds through the advertisement-reward program, and how those funds were used toward the goals of the cause.

Charities and other causes can be encouraged to post their purpose or mission on the web site 210. It is in the best interests of a charity or cause to provide some form of information about itself or a link to a pre-existing web site explaining its purpose or mission. Doing so creates an opportunity for users of the web site, which are potential donors, to learn about the cause and, thereby, create an online community or group of users in support of the cause.

Charities and other causes can be encourage to provide such information in various ways. Potential donors may contact charities and causes directly to request that they provide information about their purpose or mission. Potential donors may even volunteer to post the information on the web site 210. In the case of schools, parents of school children wanting their school to receive giveback funds may contact the principal's office or volunteer to put more of the school information on the web site 210. Members of a church or other place of worship may encourage religious leader to post information on the web site 210 to attract giveback funds.

To facilitate the community forming process, the web site 210 may provide a means of submitting information via a standardized online form or questionnaire. Information on submitted forms may be automatically posted on the web site 210. In this way, the information about all the charities/causes on the web site 210 are presented in a standard format for ease of comparison by web site users. The information given may be vetted by administrators of the web site 210 who may require public ID information, such as an employer identification number (EIN) or tax ID, and/or other information proving a claim of tax-exempt status. It will be appreciated that the information provided on the web site 210 may allow various users to rally in support of a cause and form an online community for promoting the cause.

In other embodiments of the present invention, a giveback value may be given without an express commitment being placed. For example, a merchant may agree to provide a giveback or partial giveback to a cause selected by a purchaser when the purchaser is known to have visited the merchant's web site. The giveback works as an incentive to web site visitors to make a purchase within a predetermined period of time after visiting the web site. A user or visitor to a web site would encounter a pop-up screen on their web browser. The pop-up screen may ask the user whether his navigation on a particular web site or the Internet can be tracked. The pop-up screen may allow the user to enter unique identifying information or allow the user to log into a personal account that he previously set up.

The pop-up menu may also ask the user if he wants to accept a cookie for the purpose of automatically identifying the user during future visits to the web site and, thereby, eliminate the need for the user to enter identifying information or remember a passcode. Cookies, also referred to as HTTP cookies and web cookies, can be text sent by a server to the user's web browser, stored on the user's computer, and then sent back by the web browser each time the user visits the web site that is hosted by or monitored by the server. If the user accepts the cookie, the user may bypass the pop-up screen in the future and be automatically identified when he visits a web site. Alternatively, the user may still encounter the pop-up and asked whether he wants to allow tracking of the current “window shopping” session, and if he agrees, the cookie is used to automatically identify him without need to enter information.

Tracking of the user's visits and navigation through various web sites includes associating the user's identification information with visits to a merchant's web site. Data indicating that the user visited a particular web site or web page at a particular date and time may be stored in a database. When the user makes a purchase from the merchant, the user's identification information obtained during the point of sale can be matched against the data stored in the database to confirm that the user had visited the merchant's web site within a certain period of time. The purchase can be made at the merchant's physical retail store or on the merchant's web site. If there is a match, the merchant provides the agree upon give back. In other embodiments, the pop-up screen or the merchant's web site may identify the web site as being associated with a credit card company and/or a consumer incentive program. Such identification may indicate to a web site visitor that, on condition that the she agrees to have her web visit tracked, a subsequent purchase from the merchant using a particular credit card brand may qualify her to credit card reward points, a give back, or other incentive. For example, during the point of sale, the credit card number can be obtained and the credit card company may associate the card number with an individual or individuals, such as authorized users of the credit card, and check the database of web site visits to determine whether any of those individuals visited the merchant's web site within a period of time. If a positive determination is made, an incentive from the merchant and/or credit card company is given.

In other embodiments, a credit card company can provide a web portal or Internet portal that allows users to log in and link to retail web sites of merchants. In some embodiments, the web portal can be the corporate web site of the credit card company, a web site providing credit card account access, or other web site associated with the credit card company. In some embodiments, the web portal is a proxy server through which the user access the merchants' web sites. The merchants shown on the portal may be ones that have already agreed to provide a giveback or other incentive for making a purchase after a predetermined period of time after visiting the merchants' web sites. These merchants may also be ones that are identified as incentive partners or trusted partners of the credit card company. Logging into the web portal allows a user's subsequent visit to the merchants' web sites to be tracked and data regarding the visits are stored on a database. Data from purchases from the merchants using the credit card company's brand of credit card may be automatically compared with data in the database to determine eligibility for an incentive.

While some of the embodiments above have been described in connection placement of an advertisement, it will be appreciated that the present invention encompasses the concept of a consumer making a commitment when no advertisement has been placed. For example, a vendor or merchant may have a website that functions as a virtual retail space with no particular advertisement and a consumer may give a commitment to make a purchase while visiting the website.

In some embodiments, a server is adapted to send data to a mobile communications device, such as a cell phone or personal digital assistant, operated by a user, thereby allowing the mobile communications device to be automatically loaded with advertisements that are location based. That is, data is downloaded into the mobile communications device depending on the location of the mobile communications device. In some embodiments, the data is viewed on the mobile communications device in the form of a website, while in other embodiments the data obtained on the mobile communications device in other formats, such as an audio message and/or a text message sent via SMS (short message service) protocol, SMTP (Simple Mail Transfer Protocol), and other communications protocols. When using a mobile communications device, the user can make a commitment to purchase by saying a particular word in response to an audio message and/or by pressing a key on the mobile communications device keypad.

In further embodiments, the identity of the user can be stored in the mobile communications device. When the user makes a commitment to purchase, the user's identity can be included as part of the commitment information that is transmitted by the mobile communications device.

While several particular forms of the invention have been illustrated and described, it will also be apparent that various modifications can be made without departing from the scope of the invention. It is also contemplated that various combinations or sub combinations of the specific features and aspects of the disclosed embodiments can be combined with or substituted for one another in order to form varying modes of the invention. Accordingly, it is not intended that the invention be limited, except as by the appended claims.

1. An electronic transaction system comprising:
a server adapted to send data to a user terminal operated by a user, the data enabling the user terminal to display an advertisement of a merchant and to allow the user to initiate sending of commitment information to the server, the commitment information indicating a commitment by the user to make a future purchase from the merchant, the commitment information including data regarding the identity of the user; and
a sales terminal adapted to send purchase information to the server, the purchase information indicating performance by a purchaser of a purchase from a seller, the purchase information including data regarding the identity of the purchaser;
wherein the server is further adapted to determine whether the purchase is valid by comparison of the identity of the purchaser and the identity of the user, and further adapted to allocate a giveback value to a recipient only if the purchase is valid.

2. The system of claim 1, wherein the commitment information further indicates that the future purchase will be made within an allowable time period specified by the merchant, the commitment information further includes data regarding the allowable time period, the purchase information further indicates that the performance of the purchase was at a particular time, the purchase information further includes data regarding the particular time of performance, and the server is adapted to determine whether the purchase is valid also by comparison of the particular time of performance and the allowable time period.

3. The system of claim 1, wherein the commitment information further includes data regarding the identity of the merchant, the purchase information further includes data regarding the identity of the seller, and the server is adapted to determine whether the purchase is valid also by comparison of the identity of the seller and the identity of the merchant.

4. The system of claim 1, wherein the server includes a memory for storing the commitment information and an allocation rule specified by the user, the allocation rule identifying a group of recipients and amounts from the giveback value to be allocated among the group of recipients, wherein the server is further adapted to allocate the amounts to the group of recipients in accordance with the allocation rule.

5. The system of claim 4, wherein the server is further adapted to send user-specific data to the user terminal, the user-specific data enabling the user terminal to display a menu for defining the allocation rule, the menu adapted to allow the user to select the group of recipients from a list of pre-qualified recipients.

6. The system of claim 1, wherein the server is further adapted to send merchant-specific data to a terminal operated by the merchant, the merchant-specific data indicating advertising effectiveness as a function of validated purchases.

7. The system of claim 1, wherein the server includes a first server and a second server, the first server adapted to send the data enabling the user terminal to display the advertisement, and the second server adapted to validate the purchase and allocate the giveback value.

8. The system of claim 7, wherein the first server is controlled by the merchant.

9. The system of claim 7, wherein the first server is controlled by an entity to which the merchant gives payment for the advertisement.

10. The system of claim 7, wherein the second server is controlled by a financial institution.

11. The system of claim 10, wherein the second server is further adapted to determine interest earned by the financial institution on the giveback value.

12. The system of claim 7, wherein the first server and the second server are controlled by one of the merchant, a financial institution, and an entity to which the merchant gives payment for the advertisement.

13. An electronic transaction system comprising:
a server adapted to send data to a user terminal operated by a user, the data causing the user terminal to display an advertisement of a merchant and an input element that, when acted upon by the user, causes the user terminal to send a commitment indicator indicating a commitment by the user to make a future purchase from the merchant;
a database in communication with the server, the database containing a merchant giveback rule and commitment information associated with the commitment indicator, the commitment information including a user identifier identifying the user; and
a transaction terminal in communication with the server, the transaction terminal adapted to provide transaction information regarding a purchase transaction between a buyer and a seller, the transaction information including a buyer identifier identifying the buyer;
wherein the server includes logic for determining whether the buyer identifier corresponds to the user identifier and allocating the giveback value to one or more recipients only if the buyer identifier corresponds to the user identifier, the giveback value being a function of the merchant giveback rule.

14. The system of claim 13, wherein commitment indicator further indicates that the future purchase will be made within a valid time, the commitment information further includes a valid time datum, the transaction information further includes a transaction time datum, and the logic allocates the giveback value to the one or more recipients only if the buyer identifier corresponds to the user identifier and the transaction time datum agrees with the valid time datum.

15. The system of claim 13, wherein the commitment information further includes a merchant identifier identifying the merchant, the transaction information further includes a seller identifier identifying the seller, and the logic allocates the giveback value to the one or more recipients only if the buyer identifier corresponds to the user identifier and the seller identifier corresponds to the merchant identifier.

16. The system of claim 13, wherein the merchant giveback rule corresponds to a percentage, and the logic determines the giveback value by applying the percentage to the transaction value.

17. The system of claim 13, wherein the server is adapted to send merchant-specific data to a merchant terminal operated by the merchant, the merchant-specific data causing the merchant terminal to display an indication of advertisement effectiveness, the indication being a function of one or both of a number of commitment indicators associated with the advertisement and a number of purchases corresponding to the commitment indicators.

18. The system of claim 13, wherein the data causing the user terminal to display the advertisement is sent by the server in response to a search criterion provided by the user via the user terminal.

19. The system of claim 18, wherein the search criterion involves one or more of a postal code, a geographic name, a product name, a category of goods, a of service, a category of seller, and a seller name.

20. The system of claim 13, wherein server is further adapted to send user-specific data to the user terminal, the user-specific data causing the user terminal to display a menu for specifying allocation of the giveback value, the menu adapted to allow the user to select recipients from among a plurality of recipients and to assign an allocation percentage of the giveback value to each one of the selected recipients.

21. The system of claim 20, wherein each one of the plurality of recipients is any one of an educational organization, a religious organization, a humanitarian organization, a community organization, a charitable organization, a governmental organization, a library, the user, and a lottery ticket purchasing agent.

22. The system of claim 20, wherein the server is adapted to send recipient-specific data to a recipient terminal operated by a particular recipient, the recipient-specific data causing the recipient terminal to display an amount allocated to the particular recipient.

23. The system of claim 13, wherein the database contains an allocation rule specified by the user, and the logic is also for allocating amounts from the giveback value to a plurality of escrow accounts in accordance with the allocation rule.

24. The system of claim 23, wherein the server is further adapted to send user-specific data to the user terminal, the user-specific data causing the user terminal to display amounts allocated to the plurality of escrow accounts in accordance with a criterion selected by the user, the criterion involving one or more of purchases made by the user, purchases made by a plurality of persons, purchases made from a particular seller, and purchases made from a group of sellers.

25. The system of claim 13, wherein the server is further adapted to send user-specific data to the user terminal, the user-specific data causing the user terminal to allow the user to join a group of users of the server.

26. The system of claim 25, wherein the user-specific data causes the user terminal to display a menu including groups of users of the server, the menu adapted to allow the user to become a member of a group of users selected by the user, and the user-specific data enables the user terminal for communication between the user and members of the selected group of users.

27. An electronic transaction method comprising:
allowing a user terminal operated by a user to display an advertisement of a merchant and an input element;
communicating commitment information generated in response to an input by the user at the input element, the commitment information indicating a commitment by the user to make a future purchase from the merchant, the commitment information including data regarding the identity of the user;
generating purchase information indicating performance of a purchase by a purchaser from a seller, the purchase information including data regarding the identity of the purchaser; and
communicating information to a server or to the user terminal, the information indicating that the purchase is qualified for a giveback value, the giveback value to be given to a recipient and being a function of a value of the performed purchase, the communicating performed on condition that the identity of the purchaser from the purchase information corresponds to the identity of the user from the commitment information.

28. The method of claim 41, wherein allocating the giveback value to the recipient includes transferring funds to an escrow account accessible by the recipient.

29. The method of claim 28, further comprising allocating earned interest to a party other than the recipient, the interest having been earned on the funds transferred to the escrow account.

30. The method of claim 27, wherein the commitment information further indicates that the future purchase will be made within a valid time, the commitment information further includes data regarding the valid time, the purchase information further indicates that the performance of the purchase was at a particular time, the purchase information further includes data regarding the particular time of performance, and the determining of purchase qualification further includes comparing the particular time of performance against the valid time.

31. The method of claim 27, wherein the commitment information further includes data regarding the identity of the merchant, the purchase information further includes data regarding the identity of the seller, and the determining of purchase qualification further includes comparing the identity of the seller against the identity of the merchant.

32. The method of claim 27, further comprising allocating amounts of the giveback value to a group of recipients in accordance with an allocation rule specified by the user, the allocation rule identifying the group of recipients and the amounts to be allocated.

33. The method of claim 32, further comprising causing a user terminal to display a menu for specifying the allocation rule, the menu adapted to allow the user to select the group of recipients from a list of pre-qualified recipients.

34. The method of claim 27, further comprising indicating advertising effectiveness as a function of a number of qualified purchases.

35. The method of claim 27, further comprising the merchant causing the user terminal to display the advertisement and the input element.

36. The method of claim 27, further comprising a party causing the user terminal to display the advertisement and the input element, the party being an entity to which the merchant gives payment for the advertisement.

37. The method of claim 27, further comprising a financial institution receiving the commitment information, the financial institution receiving the purchase information, the financial institution determining whether the purchase is qualified, and the financial institution allocating the giveback value.

38. An electronic transaction method comprising:
recording a visit made by an individual to a web site; followed by
processing a purchase made by the individual from a merchant;
determining whether the purchase is associated with the visit to the web site; and
providing an incentive to the individual on condition that the purchase is associated with the visit to the web site.

39. The method of claim 38, wherein:
recording the visit includes recording a first set of data identifying the individual visiting the web site; and
processing the purchase includes obtaining a second set of data including credit card information; and
determining includes comparing the first and second sets of data to each other.

40. The method of claim 38, further comprising identifying the merchant as participating in an incentive program associated with a credit card brand, wherein determining includes associating information from a credit card with the visit made to the web site.

41. The method of claim 27, further comprising:
before communicating the information indicating that the purchase is qualified for a giveback value, determining whether the purchase is qualified for the giveback value, the determining of purchase qualification including comparing the identity of the purchaser against the identity of the user; and
allocating the giveback value to the recipient only when the purchase is qualified.
